(19) United States
(12) Patent Application Publication
(10) Pub. No.: US 2017/0324313 A1
(43) Pub. Date: Nov. 9, 2017

(54) MOTOR

(71) Applicant: Nidec Corporation, Kyoto (JP)

(72) Inventors: Naohiro HASHIZUME, Kyoto (JP); Shunsuke TAKAHASHI, Kyoto (JP); Kuniaki TANAKA, Kyoto (JP); Keisuke SAITO, Kyoto (JP)

(21) Appl. No.: 15/319,485

(22) PCT Filed: Mar. 13, 2015
(86) PCT No.: PCT/JP2015/057527

§ 371 Date: Dec. 16, 2016

(30) Foreign Application Priority Data
Jun. 19, 2014 (JP) 2014-126243

(51) Int. Cl. H02K 23/26; H02K 3/28; H02K 13/00; H02K 15/00

(52) U.S. Cl. CPC H02K 23/26; H02K 15/00; H02K 3/28; H02K 13/006

(57) ABSTRACT

Provided is a motor having a rotary unit includes a shaft extending along the center axis, an armature core attached to the shaft and having six teeth radially extending toward a radial direction, a coil group of 6·n (however, n is 1 or 2) concentrated winding coils installed at the six teeth, using a coil by concentratedly winding a lead wire around one teeth as a concentrated winding coil, and a commutator electrically connected to the coil group. The stationary unit includes a pair of field magnets having same polarity facing each other, having the armature core disposed therebetween and a housing having a cylindrical yoke accommodating the pair of field magnets, wherein in the yoke, a pair of portions facing each other between the pair of magnets in a circumferential direction is a pair of magnetic poles directly facing the teeth of the armature core while having an opposite polarity to that of the magnetic poles, and a brush group contacting the commutator.

### BACKGROUND OF THE INVENTION

### 1. Field of the Invention

The present invention relates to a motor mounted with a brush.

### 2. Description of the Related Art

Japanese Patent Laid-Open Publication No. 2008-79413 discloses a motor in which a pair of magnets is disposed in a typical yoke so that magnetic poles having the same polarity face each other. In the corresponding yoke, a pair of portions positioned between the pair of magnets in a circumferential direction is provided with a pair of magnetic poles having an opposite polarity to that of the magnetic poles. By doing so, a so-called pseudo four-pole motor is configured. The so configured motor may more improve a torque than that of the motor in which a pair of magnets is disposed so that magnetic poles having different magnetic poles face each other. Further, in the motor disclosed in Japanese Patent Laid-Open Publication No. 2008-79413, twelve teeth are installed. A distributed winding is performed on the teeth to form a coil.

### SUMMARY OF THE INVENTION

However, a motor for a vehicle needs to be miniaturized to widen a vehicle space. However, in the motor disclosed in Japanese Patent Laid-Open Publication No. 2008-79413 adopting the distributed winding, the number of turns of a lead wire for each teeth may be increased to secure a constant torque and the motor may be hard to be miniaturized. If the motor disclosed in Japanese Patent Laid-Open Publication No. 2008-79413 adopts a concentrated winding, twelve coils are formed for twelve teeth. In this case, in the pseudo four-pole motor, each magnetic pole is formed at an interval of 90° and an angle range in a circumferential direction of one coil is about 30°, such that a magnetic flux interlinked toward the coil may be insufficient. For this reason, the motor is hard to efficiently generate a torque. Further, since a width of the teeth is very small, if the lead wire is wound at a high speed, the teeth are likely to be deformed. Therefore, the lead wire needs to be wound at a low speed and productivity needs to be improved.

An object of the present invention is to easily manufacture a small and high-torque motor.

### Means to Solve the Technical Problem

An exemplary preferred embodiment relating to an aspect of the present invention is a motor including: a stationary unit; a rotary unit; and a bearing portion rotatably supporting the rotary unit based on a center axis, wherein the rotary unit includes: a shaft extending along the center axis, an armature core attached to the shaft and having six teeth extending in a radial direction, a coil group of 6·n (here, n is 1 or 2) concentrated winding coils installed at the six teeth, using a coil formed by concentratedly winding a lead wire around one teeth as a concentrated winding coil, and a commutator electrically connected to the coil group, and the stationary unit includes: a pair of field magnets having same polarity facing each other, having the armature core disposed therebetween, and a housing having a cylindrical yoke accommodating the pair of field magnets, wherein in the yoke, a pair of portions facing each other between the pair of magnets in a circumferential direction is a pair of magnetic poles directly facing the teeth of the armature core while having an opposite polarity to that of the magnetic poles, and a brush group contacting the commutator.

### Effects of the Invention

According to the present invention, it is possible to easily manufacture the small and high-torque motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a motor.

FIG. 2 is a front view of the motor.

FIG. 3 is a cross-sectional view of the motor.

FIG. 4 is a plan view illustrating a portion of the motor.

FIG. 5 is a diagram illustrating a relationship between an angle range of a field magnet and a torque of the motor.

FIG. 6 is a plan view illustrating a portion of the motor.

FIG. 7 is a diagram schematically illustrating a positional relationship among a coil pair, a segment, and a brush group.

FIG. 8 is a diagram illustrating a connection structure between a coil and the segment.

FIG. 9 is a diagram illustrating the connection structure between the coil and the segment.

FIG. 10 is a diagram illustrating a connection state of the coil.

FIG. 11 is a diagram illustrating the connection state of the coil.

FIG. 12 is a diagram schematically illustrating the positional relationship among the coil, the segment, and the brush group.

FIG. 13 is a diagram illustrating the connection structure between the coil and the segment.

FIG. 14 is a diagram illustrating the connection structure between the coil and the segment.

FIG. 15 is a diagram illustrating the connection state of the coil.

FIG. 16 is a diagram illustrating the connection state of the coil.

FIG. 17 is a diagram illustrating the connection state of the coil.

FIG. 18 is a diagram illustrating results of a vibration test of the motor.

FIG. 19 is a diagram illustrating results of a vibration test of the motor.

FIG. 20 is a diagram illustrating the results of the vibration test of the motor.

FIG. 21 is a diagram illustrating the results of the vibration test of the motor.

### DETAILED DESCRIPTION OF THE PREFERRED EMBODIMENTS

In the present specification, in a direction parallel with a center axis J1 of FIG. 3, an output side of shaft is merely called an [symbol] upper side [symbol] and an opposite side is merely called a [symbol] lower side [symbol] . Expressions [symbol] upper side [symbol] and [symbol] lower side> do not necessarily coincide with a gravity direction. Further, a radial direction of the center axis J1 is simply referred to as the [symbol] radial direction [symbol] , a circumferential direction of the center axis J1 is simply referred to as the [symbol] circumferential direction [symbol] , and a direction parallel with the center axis J1 is simply referred to as the [symbol] axial direction [symbol] .

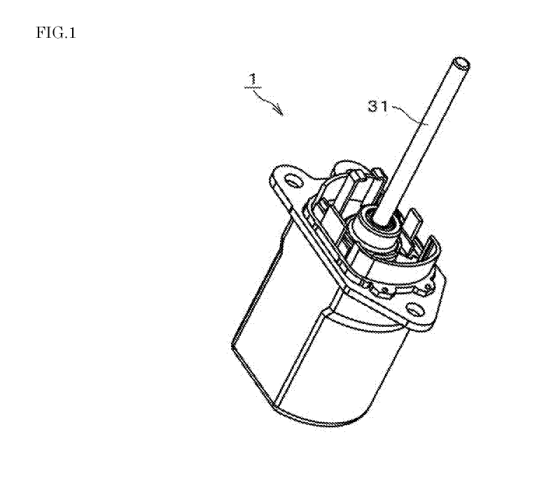

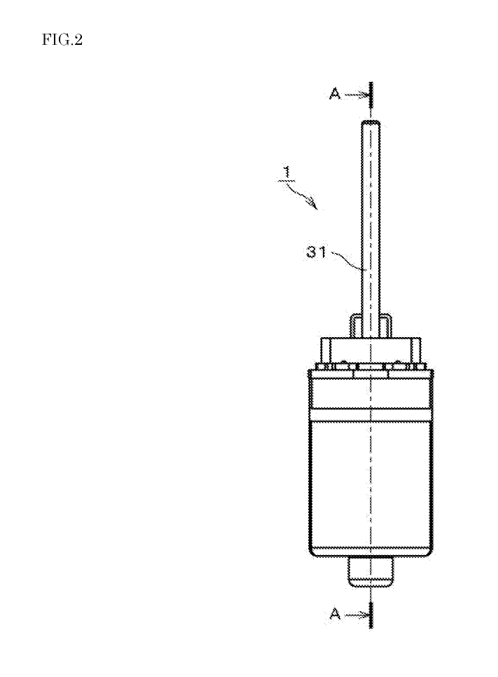

FIG. 1 is a perspective view of a motor 1 according to an exemplary preferred embodiment of the present invention and FIG. 2 is a front view of the motor 1. FIG. 3 is a longitudinal cross-sectional view of the motor 1 at a position of arrow A-A of FIG. 2. The motor 1 is a motor mounted with a brush. In detailed matters of a cross-sectional view of FIG. 3, parallel oblique lines are omitted. The motor 1 includes a stationary unit 2, a rotary unit 3, and a bearing portion 4. The bearing portion 4 supports the rotary unit 3 relative to the stationary unit 2, so as to be rotatable about the vertically extending center axis J1.

The stationary unit 2 includes a housing 1, a pair of field magnets 22, a brush group 23, and a cover portion 25. The housing 21 has substantially a cylindrical shape having a bottom portion. The cover 25 closes an upper portion of the housing 21. A pair of field magnets 22 is disposed on an inner circumferential surface of a cylindrical portion of the housing 21. The brush group 23 is disposed on a lower surface of the cover portion 25.

The rotary unit 3 includes a shaft 31, an armature core 32, a coil group 33, and a commutator 34. The shaft 31 extends along the center axis J1. The armature core 32 is formed by stacking thin electromagnetic steel sheets. The armature core 32 is attached to the shaft 31. A center axis of the shaft 31 and a center axis of the armature core 32 coincide with the center axis J1 of the motor 1.

The bearing portion 4 includes two bearing elements 41 and 42. The bearing element 42 is attached to the housing 21. The bearing element 41 is attached to the cover portion 25. The bearing elements 41 and 42 are, for example, a ball bearing or a sliding bearing. The bearing portion 4 may include only one bearing element. The rotary unit 3 is rotatably supported based on the center axis J1 by the bearing portion 4.

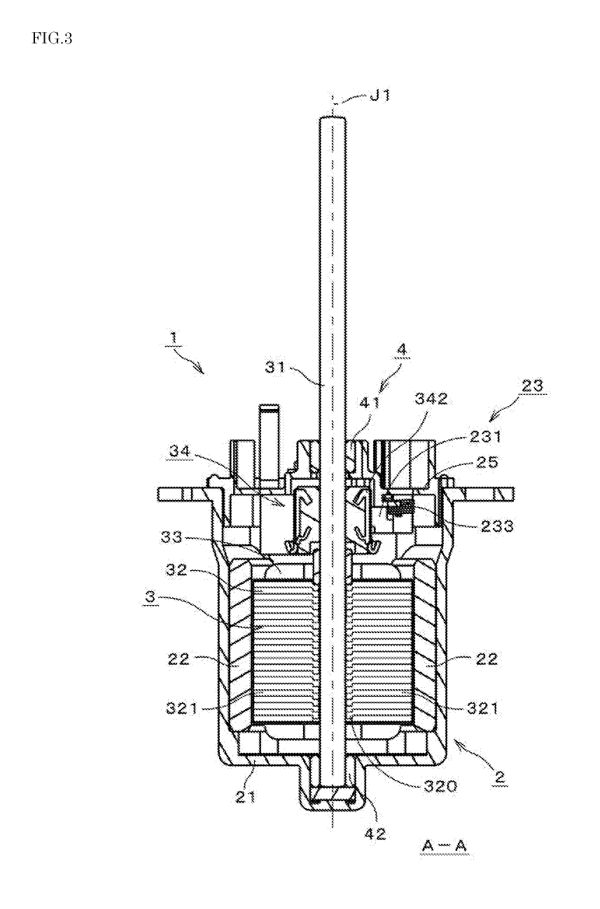

FIG. 4 is a plan view illustrating the motor 1 in which the cover 25 is separated. The housing 21 includes a yoke 211. The yoke 211 includes a pair of flat portions 212 and a pair of arc portions 213. When viewed from a plane, each arc portion 213 has an arch shape extending in the circumferential direction. The pair of arc portions 213 is positioned on the same circumference based on the center axis J1 and has the same curvature radius. The pair of arc portions 212 faces each other, having the armature core 32 disposed therebetween. When viewed from a plane, each flat portion 212 has a straight shape. The pair of flat portions 212 is parallel with each other and faces each other having the armature core 32 disposed therebetween. Each flat portion 212 is positioned at an inner side of the circumference on which the pair of arc portions 213 is disposed. Each flat portion 212 connects between ends of the pair of arc portions 213. By doing so, the pair of flat portions 212 and the pair of arc portions 213 are connected in an annular shape. That is, the yoke 211 has a cylindrical shape enclosing the armature core 32.

Each field magnet 22 has an arch shape extending in the circumferential direction. The field magnet 22 is attached to a surface on a radially inner side of the arc portion 213 and is accommodated in the yoke 211. The field magnet 22 has a symmetric shape to a center of the arc portion 213 in the circumferential direction and a side including the center axis J1. The pair of field magnets 22 faces each other, having the armature core 32 disposed therebetween. A center of one field magnet 22 in the circumferential direction is spaced apart from a center of the other field magnet 22 by 180°. In connection with the circumferential direction, both end portions of each field magnet 22 each face the pair of flat portions 212 at an interval. Surfaces of the corresponding both end portions, that is, both end surfaces are parallel with each other in the radial direction. In the pair of field magnets 22, the magnetic poles having the same polarity face each other.

A pair of portions 214 facing each other between the pair of field magnets 22 in the circumferential direction in the yoke 211 is provided with a pair of magnetic poles. Hereinafter, the portion 214 is called a [symbol] magnetic pole configuration portion 214 [symbol] . The pair of magnetic pole configuration portions 214 is included in the pair of flat portions 212, respectively. The magnetic pole configuration portion 214 has an opposite polarity to that of the magnetic pole of the center axis J1 in the field magnet 22. A magnet is not installed between the magnetic pole configuration portion 214 and the armature core 32. That is, the magnetic configuration portion 214 directly faces teeth 321 of the armature core 32 to be described below. In the motor 1, the field magnet 22 and the magnetic pole configuration portion 214 are alternately disposed in the circumferential direction and the number of magnetic poles is 4. By doing so, the pseudo four-pole motor 1 is configured.

The armature core 32 includes an annular core back 320 (see FIG. 3) and a plurality of teeth 321. The shaft 31 is inserted into the core back 320. Each teeth 321 extends radially outward from the core back 320. According to this preferred embodiment, the number of teeth 321 is six. Some of the teeth 321 and the field magnet 22 face each other in the radial direction. Each teeth includes a winding portion 322 and a tip portion 323. The winding portion 322 linearly extends in the radial direction. The tip portion 323 is expanded from an end portion of outside in a radial direction of the winding portion 322 toward both sides in the circumferential direction. An angle range in the circumferential direction of the tip portion 323 is smaller than that of the field magnet 22. Both ends and a center in the circumferential direction of the tip portion 323 include an outer circumferential surface positioned on the same circumference based on the center axis J1. A groove portion, which is recessed radially inward, is provided between both ends and a center in the circumferential direction. In other words, the tip portion 323 includes a protruding portion 324 protruding from the center in the circumferential direction toward the outside in the radial direction. The motor 1 is designed to reduce a caulking torque due to the protruding portion 324. A width of an air gap which is the shortest distance between the teeth 321 and the field magnet 22 when the teeth 321 faces the field magnet 22 in the radial direction is equal to that of an air gap between the teeth 321 and the magnetic pole configuration portion 214 when the teeth 321 faces the magnetic pole configuration portion 214 in the radial direction.

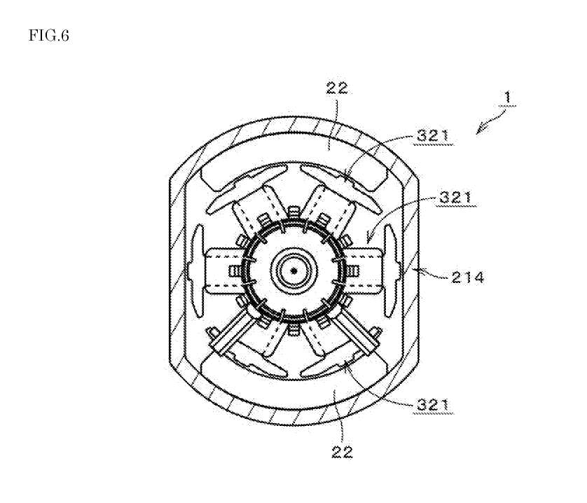

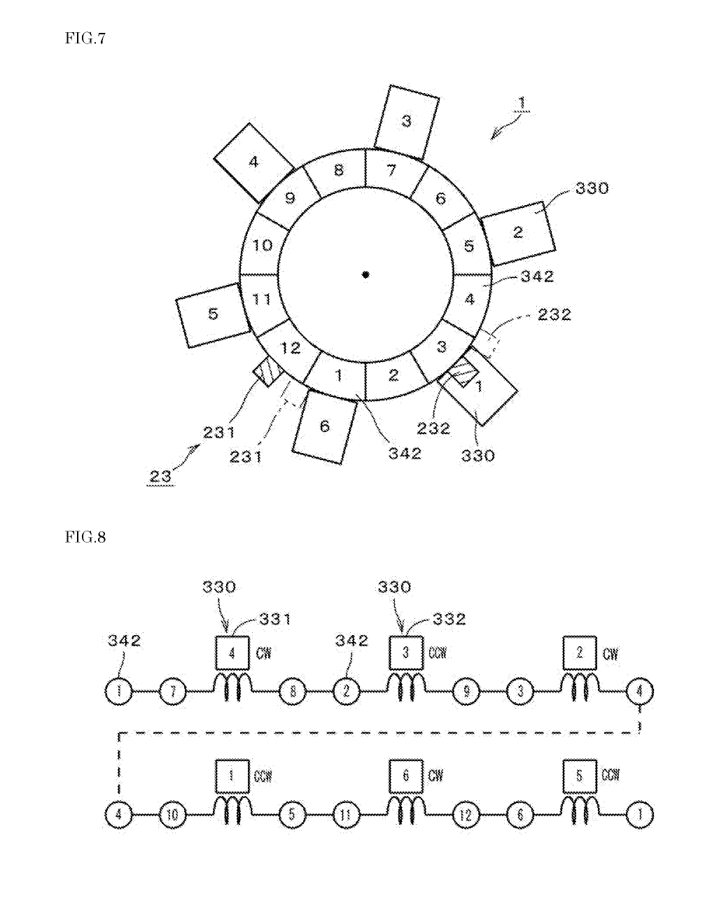

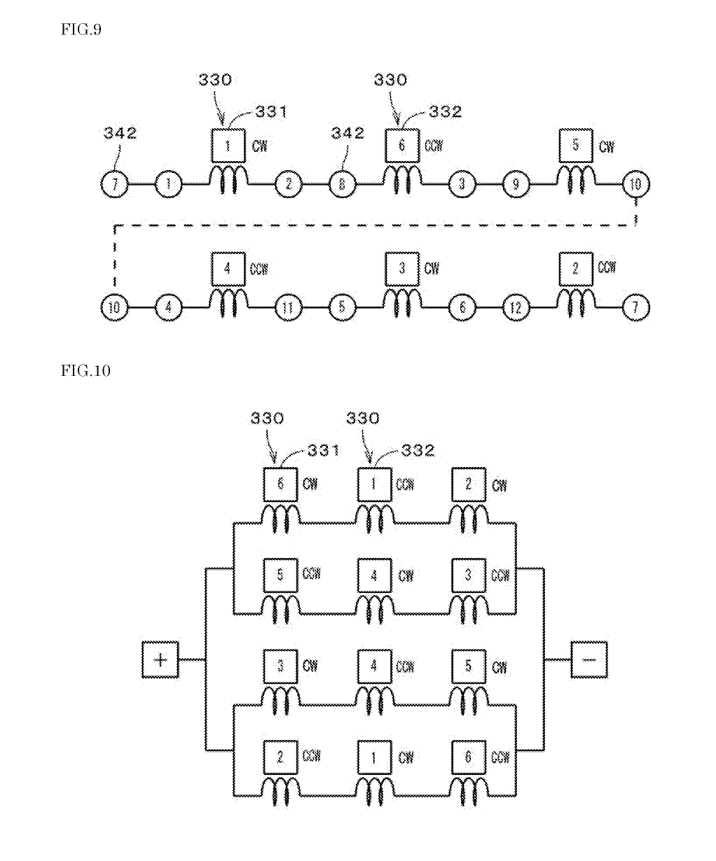

A coil formed by concentratedly winding a lead wire around one teeth 321 is a concentrated winding coil, such that the coil group 33 is twelve concentrated winding coils. In each winding portion 322, two concentrated winding coils are formed in one coil pair 330. That is, each coil pair 330 is a first concentrated winding coil 331 and a second concentrated winding coil 332 (see FIGS. 8 and 9 to be described below). The first concentrated winding coil 331 is wound with the lead wire in a constant winding direction. The second concentrated winding coil 332 is wound with the lead wire in an opposite direction to the winding direction of the first concentrated winding coil 331. In the coil group 33, six first concentrated winding coils 331 are installed at six teeth 321, respectively and six second concentrated winding coils 332 are installed at six teeth 321, respectively. A current flows in the coil group 33 to generate a torque based on the center axis J1 between the rotary unit 3 and the field magnet 22 and the magnetic pole configuration portion 214.

The commutator 34 is electrically connected to the coil group 33. The commutator 34 includes twelve segments 342 arranged in the circumferential direction. The number of segments 342 is two times as many as the number of teeth 321. The segment 342 is electrically connected to the lead wire from the concentrated winding coils 331 and 332. Each segment may contact the brush group 23. The brush group 23 includes a first brush 231 and a second brush 232. The first brush 231 and the second brush 232 are disposed at a position spaced by 90° in the circumferential direction. Further, the first brush 231 and the second brush 232 are disposed at the center in the circumferential direction of the field magnet 22 or are disposed at the position in the circumferential direction different from the center of the circumferential direction of the magnetic pole configuration portion 214. Preferably, the first brush 231 or the second brush 232 is disposed at a position different from the position in the circumferential direction to which the commutator 34 and the magnetic pole configuration portion 214 are closest. By doing so, the first brush 231 or the second brush 232 may be disposed without increasing a distance between the pair of flat portions 212. Alternatively, a size of the first brush 231 or the second brush 232 may be increased in the radial direction and lifespan thereof may be expanded. In particular, if the first brush 231 and the second brush 232 are disposed in an area between a line connecting between an end portion in the circumferential direction of one arc portion 213 and the center and a line connecting between an end portion in the circumferential direction of the other arc portion 213 and the center, it is possible to increase the size in the radial direction of the first brush 231 and the second brush 232.

In the pseudo four-pole motor 1, it is assumed that the number of teeth 321 is an even number. In this case, a magnetic suction force is applied to the rotary unit 3 at a biased position in the circumferential direction and vibration and noise are increased upon the rotation. Further, when the number of teeth 321 is 8, 10, or 12, an angle range in the circumferential direction of one coil is reduced and in the pseudo four-pole motor, a torque may not be efficiently generated. In addition, when the number of teeth 321 is four, since the positional relationship for the magnetic poles of all the teeth 321 is the same, the caulking torque is increased.

In this respect, in the motor 1 of FIG. 4, the number of teeth 321 is six. By doing so, the angle range in the circumferential direction of the coil may be increased to some extent. As a result, in the pseudo four-pole motor 1, the torque is efficiently generated and thus the high-torque motor 1 may be implemented. Further, it is possible to prevent the caulking torque from increasing. In addition, since the magnetic suction force is applied to the rotary unit 3 at the equal position in the circumferential direction, the vibration or the noise may be reduced upon the rotation. The concentrated winding coils 331 and 332 may be formed at each of the teeth 321 to miniaturize the motor 1. Since the width of the teeth 321 in the circumferential direction may be increased to some extent, it is possible to easily wind the lead wire at a high speed upon the formation of the coil. As a result, it is possible to easily manufacture the motor 1.

FIG. 5 is a diagram illustrating the relationship between the angle range which is the width of the field magnet 22 in the circumferential direction and the torque in the motor 1. In FIG. 5, a vertical axis represents the torque and a horizontal axis represents an angle θ illustrated in FIG. 4. The angle θ is an angle formed by a line connecting between the center of the magnetic pole configuration portion 214 in the circumferential direction and the center axis J1 and a line between the end surface of the field magnet 22 in the circumferential direction and the center axis J1. When the angle θ is reduced, the angle range of the field magnet 22 in the circumferential direction is increased. In FIG. 5, an average torque with a sign L1 is represented by a solid line and a torque ripple with a sign L2 is represented by a broken line. The torque ripple is a variation width of the torque upon the rotation of the motor 1.

Preferably, an angle θ ranges from 31° to 68°, that is, an angle range of the field magnet 22 ranges from 44° to 118°. By doing so, the torque ripple is equal to or less than the average torque. Further, when the angle θ is equal to or more than 40°, that is, the angle range of the field magnet 22 is equal to or less than 100°, the end portions of each field magnet 22 and the flat portion 212 do not come into contact with each other in the circumferential direction. In this case, a magnetic flux of the field magnet 22 is shorted to the flat portion 212 to prevent the torque ripple from increasing. To secure the lower torque ripple, the angle θ is equal to or more than 45°, that is, the angle range of each field magnet 22 is preferably equal to or less than 90°. A consumed amount of the magnetic material in the field magnet 22 may be reduced, a weight of the motor 1 may be reduced, and manufacturing costs of the motor 1 may be reduced, by reducing the angle range of the field magnet 22.

In FIG. 5, except for the case in which the angle θ is equal to or less than 30°, the average torque is gradually reduced as the angle θ is increased. To secure the high average torque to some extent, the angle θ is equal to or less than 60°, that is, the angle range of the field magnet 22 is preferably equal to or more than 60°. Here, as illustrated in FIG. 4, the state in which the winding portion 322 at one teeth 321 is opposite to the center of the first field magnet 22 in the circumferential direction in the radial direction is assumed. In this state, if the angle range of the field magnet 22 is equal to or more than 60°, some of the tip portions 323 at each of the two teeth 31 adjacent to both sides in the circumferential direction with respect to the corresponding teeth 321 approximately faces the field magnet 22 in the radial direction. By doing so, the magnetic suction force between one of the two teeth 321 and the field magnet 22 and a magnetic repulsive force between the other of the two teeth 321 and the field magnet 22 may be increased. As a result, it is possible to increase the torque in the motor 1. More preferably, the angle range of the field magnet 22 is equal to or more than 70°. By doing so, the range in which the tip portion 323 of the teeth 321 adjacent in the circumferential direction with respect to the corresponding teeth 321 and the field magnet 22 face each other in the radial direction may be increased in the state in which one teeth 321 faces the field magnet 22, and the torque may be more increased.

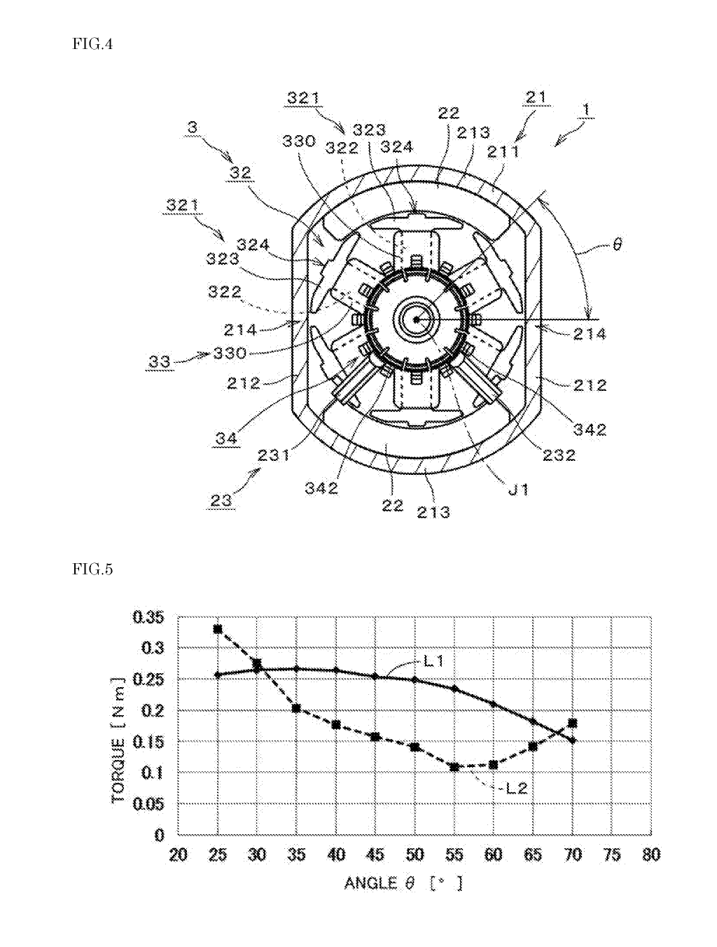

Further, as illustrated in FIG. 6, the state in which one teeth 32 faces the center in the circumferential direction at one magnetic pole configuration portion 214 in the radial direction is assumed. In this state, at least some of each of the two teeth 321 adjacent to both sides in the circumferential direction with respect to the corresponding teeth 321 preferably faces any one of the field magnets 22 in the radial direction. By doing so, the magnetic suction force between one of the two teeth 321 and the field magnet 22 and a magnetic repulsive force between the other of the two teeth 321 and the field magnet 22 may be increased. As a result, it is possible to increase the torque in the motor 1.

FIG. 7 is a diagram schematically illustrating the positional relationship among a coil pair 330, a segment 342, and a brush group 23. In FIG. 7, Nos. 1 to 6 are allocated to six coils pairs 330 counterclockwise. Nos. 1 to 12 are allocated to twelve segments 342. The position in the circumferential direction of the coil pair 330 coincides with the position in the circumferential direction of the teeth 321. The center axis of the coil pair 330 extends in the radial direction and coincides with the center in the circumferential direction of the first segment 342. In detail, the center axis of No. 1 coil pair 330 overlaps with the center in the circumferential direction of No. 3 segment 342. As described below, since twelve segments 342 are disposed in the circumferential direction at an equal angle interval, the center axis of No. 1 coil pair 330 is positioned to be spaced by 45° in the circumferential direction with respect to a boundary between No. 1 segment 342 and No. 2 segment 342. When both sides of No. 1 segment 342 and No. 2 segment 342 come into contact with the first brush 231, No. 1 coil pair 330 faces just below FIG. 7, that is, the center in the circumferential direction of the first field magnet 22. Similarly, the center axis of No. 2 coil pair 330 is positioned to be spaced by 45° in the circumferential direction with respect to the boundary between No. 3 segment 342 and No. 4 segment 342.

As illustrated in FIG. 3, the first brush 231 is pressed toward the segment 342 by an elastic portion 233. The same goes for the second brush 232. In the state illustrated by a solid line in FIG. 7, the first brush 231 comes into contact with No. 12 segment 342. The second brush 232 comes into contact with No. 3 segment 342. The first brush 231 and the second brush 232 are each connected to a positive pole and a negative of a power supply. A potential of the first brush 231 is a predetermined first potential, and the first potential is applied to the segment 342. A potential of the second brush 232 is a second potential different from the first potential, and the second potential is applied to the other segment 342.

FIGS. 8 and 9 are diagrams illustrating a connection structure between the coil and the segment 342. A circle enclosing the shown numbers represents the segment 342. A square enclosing a number represents the first concentrated winding coil 331 or the second concentrated winding coil 332 of the coil pair 330 or the teeth 321. Here, the first concentrated winding coil 331 is formed by winding the lead wire around the teeth 321 clockwise when viewed from a radially outer side and [symbol] CW [symbol] is shown on the right hand side of the square that surrounds the number. The second concentrated winding coil 332 is formed by winding the lead wire around the teeth 321 counterclockwise when viewed from the outside in the radial direction and [symbol] CCW [symbol] is represented at the right of the square enclosing a number. Hereinafter, the connection structure between the coil pair 330 and the segment 342 is called a [symbol] winding structured [symbol] . In FIGS. 8 and 9, the winding structure is illustrated in two stages but as illustrated by a broken line, they are continued at one lead wire in order.

In the connection structure of FIG. 8, the lead wire is locked to No. 1 segment 342 and then is locked to No. 7 segment 342. Locking the lead wire to the segment 342 means an electrical connection of the lead wire to the segment 342. Next, the lead wire is wound around No. 4 teeth 321 clockwise and the first concentrated winding coil 331 of No. 4 coil pair 330 is formed. The lead wire is locked from No. 4 teeth 321 to No. 8 segment 342 and No. 2 segment 342 in order. Next, the lead wire is wound around No. 3 teeth 321 counterclockwise and the second concentrated winding coil 332 of No. 3 coil pair 330 is formed. Next, as illustrated in FIG. 8, the locking of the lead wire to the segment 342 and the winding around the teeth 321 are repeatedly performed and three first concentrated winding coils 331 and three second concentrated winding coils 332 are formed. Finally, the lead wire is locked to No. 1 segment 342.

In the connection structure of FIG. 9, the lead wire is locked to No. 7 segment 342 and then is locked to No. 1 segment 342. Next, the lead wire is wound around No. 1 teeth 321 clockwise and the first concentrated winding coil 331 of No. 1 coil pair 330 is formed. The lead wire is locked from No. 1 teeth 321 to No. 2 segment 342 and No. 8 segment 342 in order. Next, the lead wire is wound around No. 6 teeth 321 counterclockwise and the second concentrated winding coil 332 of No. 6 coil pair 330 is formed. Next, as illustrated in FIG. 9, the locking of the lead wire to the segment 342 and the winding around the teeth 321 are repeatedly performed and three first concentrated winding coils 331 and three second concentrated winding coils 332 are formed. Finally, the lead wire is locked to No. 7 segment 342.

As illustrated in FIG. 7, the first brush 231 and the second brush 232 are disposed at a position spaced by 90° in the circumferential direction. Meanwhile, twelve segments 342 are disposed at an interval of 30° in the circumferential direction. Therefore, at least one segment 342 is always positioned between the segment 342 contacting the first brush 231 and the segment 342 contacting the second brush 232 while the rotary unit 3 rotates. Hereinafter, the segment 342 positioned between the segment 342 contacting the first brush 231 and the segment 342 contacting the second brush 232 is called an [symbol] intermediate segment 342 [symbol] .

Further, a potential of the segment 342 contacting the first brush 231 is a first potential similar to the first brush 231. A potential of the segment 342 contacting the second brush 232 is a second potential similar to the second brush 232. In the connection structure of FIGS. 8 and 9, the first concentrated winding coil 331 and the second concentrated winding coil 332 are connected in series through at least one intermediate segment 342 between the segment 342 of the first potential and the segment 342 of the second potential. Therefore, the potential of at least one intermediate segment 342 is between the first potential and the second potential. Actually, the potential of the segment 342 spaced from the segment 342 contacting the first brush 231 in the circumferential direction by 180° is the first potential. The potential of the segment 342 spaced from the segment 342 contacting the second brush 232 in the circumferential direction by 180° is the second potential. Therefore, when viewed along the circumferential direction, the potential of the segment 342 at a period of 180° is gradually changed between the first potential and the second potential.

As illustrated in a solid line in FIG. 7, when the first brush 231 contacts No. 12 segment 342 and the second brush 232 contacts No. 3 segment 342, the connection state between the first and second concentrated winding coils 331 and 332 is as illustrated in FIG. 10. In a circuit portion of an upper portion of FIG. 10, Nos. 6, 1, and 2 coils connected in series and Nos. 5, 4, and 3 coils connected in series are connected in parallel. In a circuit portion of a lower portion of FIG. 10, Nos. 3, 4, and 5 coils connected in series and Nos. 2, 1, and 6 coils connected in series are connected in parallel. The circuit portion of the upper portion and the circuit portion of the lower portion of FIG. 10 are connected in parallel.

As illustrated in a two-dot chain line in FIG. 7, when the first brush 231 contacts Nos. 12 and 1 segments 342 and the second brush 232 contacts Nos. 3 and 4 segments 342, the connection state between the first and second concentrated winding coils 331 and 332 is as illustrated in FIG. 11. In a circuit portion of an upper portion of FIG. 11, Nos. 6 and 1 coils connected in series and Nos. 4, and 3 coils connected in series are connected in parallel. In a circuit portion of a lower portion of FIG. 11, Nos. 3 and 4 coils connected in series and Nos. 1, and 6 coils connected in series are connected in parallel. The circuit portion of the upper portion and the circuit portion of the lower portion of FIG. 11 are connected in parallel.

In FIG. 7, the positions of the first and second brushes 231 and 232 rotate in the circumferential direction but actually, the coil pair 330 and the segment 342 rotate with respect to the first and second brushes 231 and 232. An angle between the first brush 231 and the second brush 232 in the circumferential direction is an integer multiple of an angle between the adjacent segments to each other. The motor 1 is always in any one of the state in which each of the first and second brushes 231 and 232 comes into contact with only one segment 342 and the state in which each of the first and second brushes 231 and 232 comes into contact with two segments 342. Depending on the rotation of the rotary unit 3, the connection states of the first and second concentrated winding coils 331 and 332 each corresponding to FIG. 10 and FIG. 11 are sequentially repeated.

Here, a motor 1a according to another example will be described below. FIG. 12 is a diagram schematically illustrating the positional relationship among a coil, the segment 342, and the brush group 23 of the motor 1a. FIG. 12 corresponds to FIG. 7. In the motor 1a, one first concentrated winding coil 331 is installed at each teeth 321 and the second concentrated winding coil 332 is not installed. The motor 1a includes six first concentrated winding coils 331 and six segments 342. Further, the preferred angle range of the field magnet 22 in the motor 1a is similar to the motor. Only one second concentrated winding coil 332 may be installed at each teeth 321.

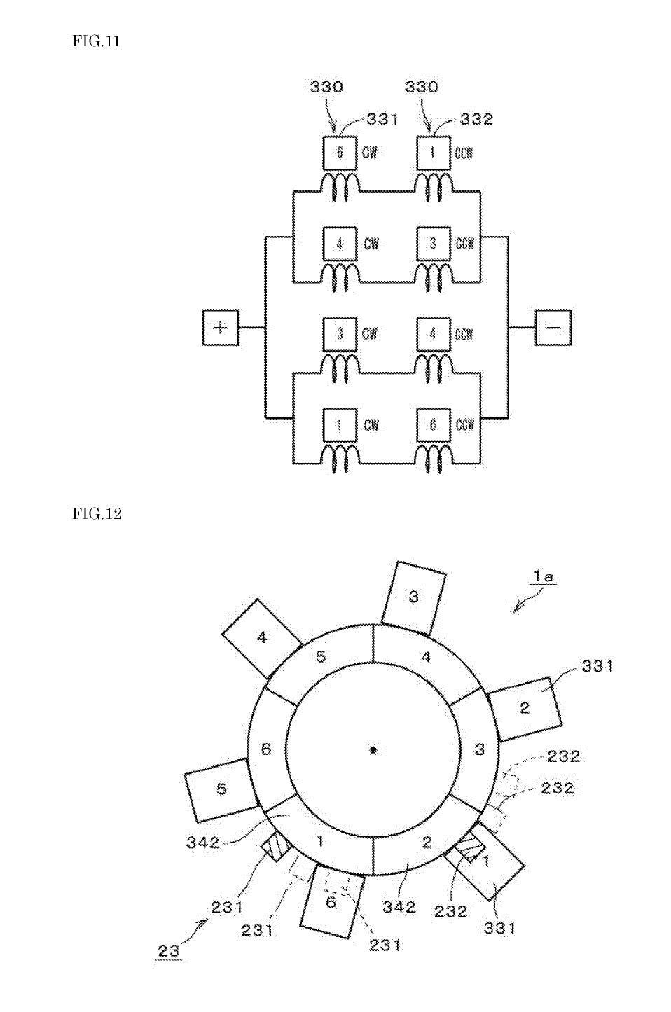

FIGS. 13 and 14 are diagrams illustrating the connection structure between the coil 331 and the segment 342. In the connection structure of FIG. 13, the lead wire is locked to No. 1 segment 342 and then is locked to No. 4 segment 342. Next, the lead wire is wound around No. 4 teeth 321 clockwise and the first concentrated winding coil 331 is formed. The lead wire is locked from No. 4 teeth 321 to No. 5 segment 342 and No. 2 segment 342 in order. Next, the lead wire is wound around No. teeth 321 clockwise and the first concentrated winding coil 331 is formed. Next, as illustrated in FIG. 13, the locking of the lead wire to the segment 342 and the winding around the teeth 321 are performed and three first concentrated winding coils 331 are formed. Finally, the lead wire is locked to No. 1 segment 342.

In the connection structure of FIG. 14, the lead wire is locked to No. 4 segment 342 and then is locked to No. 1 segment 342. Next, the lead wire is wound around the first teeth 321 clockwise and the first concentrated winding coil 331 is formed. The lead wire is locked from No. 1 teeth 321 to No. 2 segment 342 and No. 5 segment 342 in order. Next, the lead wire is wound around No. 5 teeth 321 clockwise and the first concentrated winding coil 331 is formed. Next, as illustrated in FIG. 14, the locking of the lead wire to the segment 342 and the winding around the teeth 321 are performed and three first concentrated winding coils 331 are formed. Finally, the lead wire is locked to No. 4 segment 342.

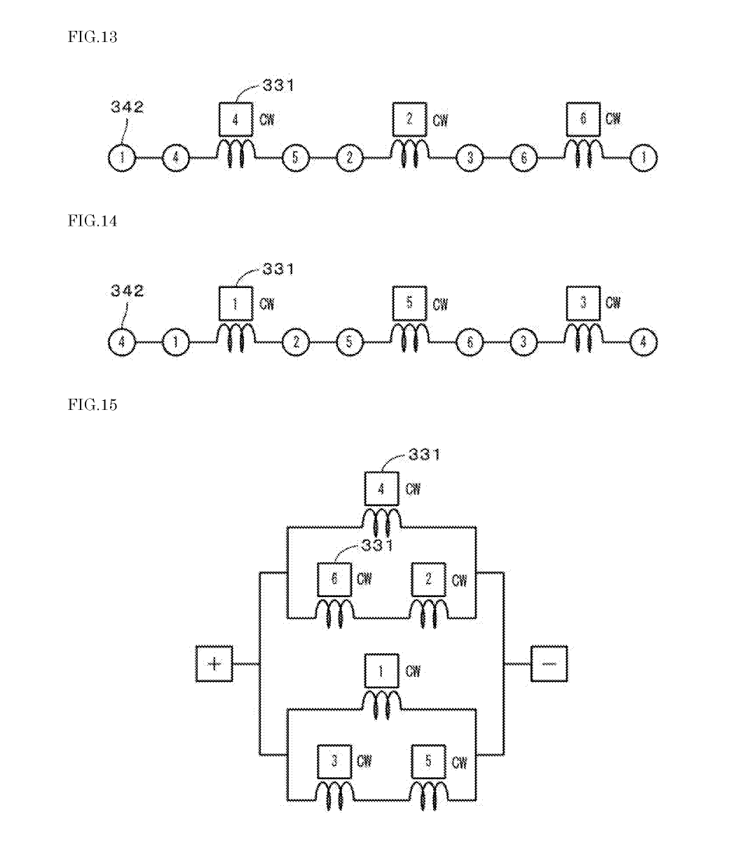

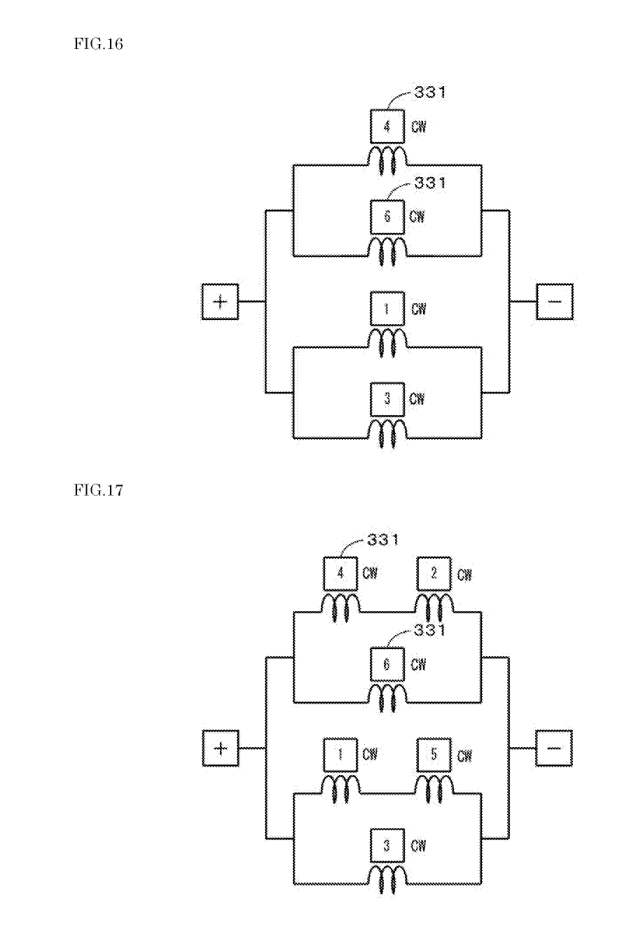

As illustrated in a solid line in FIG. 12, when the first brush 231 contacts No. 1 segment 342 and the second brush 232 contacts No. 2 segment 342, the connection state of the first concentrated winding coil 331 is as illustrated in FIG. 15. As illustrated in a two-dot chain line in FIG. 12, when the first brush 231 contacts No. 1 segment 342 and the second brush 232 contacts Nos. 2 and 3 segments 342, the connection state of the first concentrated winding coil 331 is as illustrated in FIG. 16. As illustrated in a broken line in FIG. 12, when the first brush 231 contacts No. 1 segment 342 and the second brush 232 contacts No. 3 segment 342, the connection state of the first concentrated winding coil 331 is as illustrated in FIG. 17. As described above, in the motor 1a of FIG. 12, depending on the rotation of the rotary unit 3, the connection state of the first concentrated winding coil 331 corresponding to FIGS. 15 to 17, respectively, are repeated in order.

In the motor 1 of FIG. 7, the potential of the segment 342 is gradually changed in the circumferential direction, such that the difference in the potential between the segments is smaller compared to the motor 1a of FIG. 12. As a result, a spark occurring between the brush and the segment is reduced and a brush wear is reduced, thereby improving the lifespan of the brush. Further, in the motor 1 of FIG. 7, a contact pattern between the brushes 231 and 232 and the segment 342, that is, the connection state of the coil are two, while in the motor 1a of FIG. 12, the connection state of the coil becomes three. When the connection state of the coil is switched, electromagnetic noise occurs due to a magnetic induction of the coil. Further, frequency bands of the occurring electromagnetic noise are different due to the connection state of the coil before and after the switching. Therefore, in the motor 1 of FIG. 7, it is possible to suppress electro magnetic interference (EMI) using a filter corresponding to a frequency band narrower than that of the motor 1a of FIG. 12.

Here, the case in which a resistance value of one coil is larger than a resistance value R of another coil by α is assumed. For example, in the motor 1a, a resistance value of No. 4 first concentrated winding coil 331 is set to be R+α. In this case, in a circuit portion of an upper portion of FIG. 15, a ratio of a resistance value of a circuit element including No. 4 first concentrated winding coil 331 and a resistance value of a circuit element including Nos. 6 and 2 first concentrated winding coils 331 becomes (R+α) to 2R. Meanwhile, in the motor 1, a resistance value of No. 4 first concentrated winding coil 331 is set to be R+α. In this case, a circuit portion of an upper portion of FIG. 11, a ratio of a resistance value of a circuit element including No. 4 first concentrated winding coil 331 and No. 3 second concentrated winding coil 332 and a resistance value of a circuit element including No. 6 first concentrated winding coil 331 and No. 1 second concentrated winding coil 332 becomes (2R+α) to 2R. The ratio of the resistance value affects a value of current flowing in the two circuit elements and the magnetic suction force of the coil in the corresponding two circuit elements. As described above, as compared with the motor 1a, the motor 1 is less affected by the variation of the resistance value of the coil. Therefore, the non-uniform magnetic suction force of the coil due to the variation of the resistance value of the coil is smaller than that of the motor 1a and the vibration or the noise is more reduced.

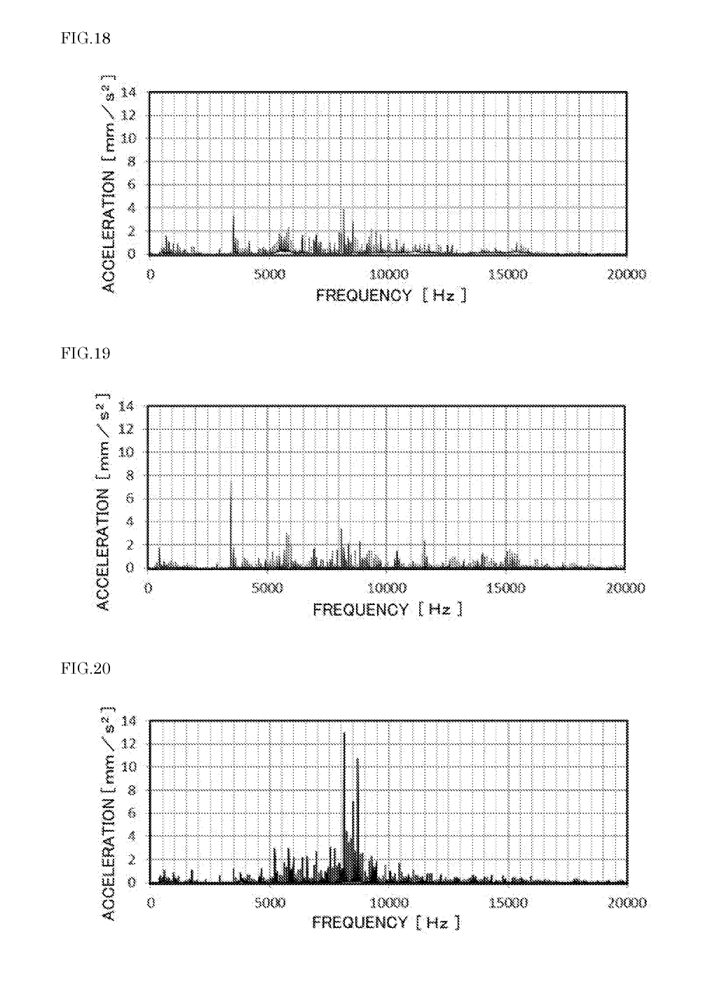

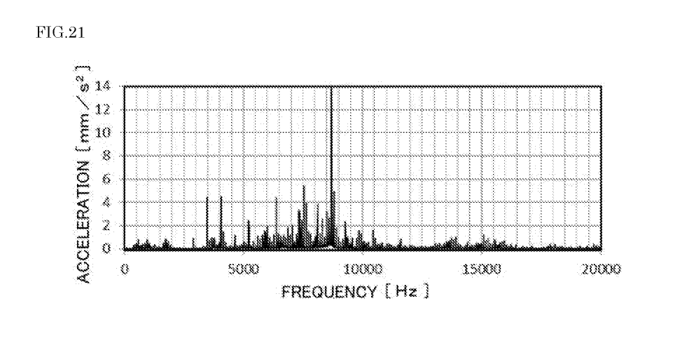

FIGS. 18 and 19 are diagrams illustrating the results of the vibration test for the motor 1 including twelve segments 342. FIGS. 20 and 21 are diagrams illustrating the results of the vibration test for the motor 1a including six segments 342. In these vibration tests, when a current does not flow in the coil and the rotary unit 3 rotates clockwise or counterclockwise by external driving mechanism, the vibration of the motor 1 and 1a is measured. FIGS. 18 and 20 illustrate the results of rotating the rotary unit 3 clockwise. FIGS. 19 and 21 illustrate the results of rotating the rotary unit 3 counterclockwise. It may be appreciated from FIGS. 18 to 21 that even in the case of the external driving, in the motor 1 including twelve segments 342, the vibration is more reduced compared to the motor 1a including six segments 342.

As described above, in the motors 1 and 1a, one or two concentrated winding coils are formed at each winding portion 322. In other words, the coil group 33 in the motors 1 and 1a is 6·n (however, n is 1 or 2) concentrated winding coil installed at six teeth 321. Further, the connection structure between the coil and the segment 342 may be appropriately changed. A shape of the yoke 211 may be appropriately changed to meet the purposes, etc., of the motors 1 and 1a.

The configurations of the above-mentioned preferred embodiments and each modification example may be appropriately combined unless being contradictory to each other.

### INDUSTRIAL APPLICABILITY

The present invention may be used for the multipurpose motor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A motor, comprising:
a stationary portion;
a rotary unit; and
a bearing portion rotatably supporting the rotary unit based on a center axis,
wherein the rotary unit includes:
a shaft extending along the center axis,
an armature core attached to the shaft and having six teeth radially extending toward a radial direction,
a coil group of 6·n (however, n is 1 or 2) concentrated winding coils installed at the six teeth, using a coil formed by concentratedly winding a lead wire around one teeth as a concentrated winding coil, and
a commutator electrically connected to the coil group, and
the stationary unit includes:
a pair of field magnets having same polarity facing each other, having the armature core disposed therebetween, and
a housing having a cylindrical yoke accommodating the pair of field magnets, wherein in the yoke, a pair of portions facing each other between the pair of field magnets in a circumferential direction is a pair of magnetic poles directly facing the teeth of the armature core while having an opposite polarity to that of the magnetic poles, and
a brush group contacting the commutator.

2. The motor of claim 1, wherein at least a portion of each of the two teeth adjacent to both sides in a circumferential direction with respect to the teeth faces any one of the pair of field magnets in a radial direction, in a state in which one teeth faces a center of the circumference direction at each of the pair of magnetic poles in the radial direction.

3. The motor of claim 1, wherein each of the pair of field magnets is an arc shape extending in the circumferential direction in an angle range of 90° or less, and
each of the six teeth includes:
a winding portion provided with a concentrated winding coil, and
a tip portion expanded from an end of an outside in a radial direction of the coil portion toward both sides in a circumferential direction,
a portion of the tip portion at each of the two teeth adjacent both sides in the circumferential direction with respect to the teeth faces the field magnet, in a state in which the winding portion at one teeth faces a center of first field magnet in the circumferential direction in a radial direction.

4. The motor of claim 3, wherein the tip portion is provided with a protruding portion protruding toward from the center in the circumferential direction toward an outside in the radial direction.

5. The motor of claim 1, wherein the commutator is provided with twelve segments arranged in the circumferential direction to contact the brush group,
the brush group includes a first brush of a first potential and a second brush of a second brush, and
at least one segment is always positioned between a segment contacting a first brush and a segment contacting the second brush while the rotary unit rotates and the potential of the at least one segment is between the first potential and a second potential.

6. The motor of claim 5, wherein the first brush and the second brush are disposed at a position spaced by 90° in the circumferential direction.

7. The method of claim 5, wherein the coil group includes:
six first concentrated winding coils installed at the six teeth, respectively, and winding a lead wire therearound in a constant winding direction, and
six second concentrated winding coils installed at the six teeth, respectively, and winding a lead wire therearound in an opposite direction to a constant winding direction.

8. The motor of claim 1, wherein the yoke includes:
a pair of flat portion including the pair of magnetic pole and parallel with each other; and
a pair of arc attached with the pair of field magnet;
the pair of flat portions and the pair of arc portions are connected to each other in an annular shape, and
both end portions of the pair of field magnets face each of the pair of flat portions through an interval with respect to the circumferential direction.
